(19) United States
(12) Patent Application Publication
(10) Pub. No.: US 2018/0052960 A1
(43) Pub. Date: Feb. 22, 2018

(54) COMPUTER-IMPLEMENTED METHODS OF PROMOTING PATIENT COMPLIANCE WITH ONE OR MORE RECOMMENDED TREATMENTS OR SCREENING REGIMENS

(71) Applicants: Anup Raina, Malvern, PA (US); Drexel University, Philadelphia, PA (US)

(72) Inventors: Richard Joseph Hamilton, Jenkintown, PA (US); Patrick Craven, Moorestown, NJ (US); Anup Raina, Malvern (US)

(73) Assignee: Drexel University, Philadelphia, PA (US)

(21) Appl. No.: 15/547,878

(22) PCT Filed: Jan. 28, 2016
(86) PCT No.: PCT/US2016/015371

§ 371 Date: Aug. 1, 2017

Related U.S. Application Data
(60) Provisional application No. 62/111,984, filed on Feb. 4, 2015.

(51) Int. Cl. G06F 19/00

(52) U.S. Cl. CPC G06F 19/328; G06F 19/322

(57) ABSTRACT

One aspect of the invention provides a computer-implemented method of promoting patient compliance with one or more recommended screening regimens. The computer-implemented method includes: receiving one or more selected from the group consisting of: demographic information, patient history, and family history from a patient; obtaining a list of recommended screenings for patients having the demographic information, patient history, or family history pertaining to a patient; receiving at least one selected from the group consisting of: digital billing information and digital health information related to the patient; parsing the digital billing information or digital health information; and identifying whether a potential match exists between the one or more recommended screenings and the digital billing information or digital health information.

### CROSS-REFERENCE TO RELATED APPLICATION

This application claims priority to U.S. Provisional Patent Application Ser. No. 62/111,984, filed Feb. 4, 2015. The entire content of this application is hereby incorporated by reference herein.

### BACKGROUND OF THE INVENTION

Presently, there are multiple sources of siloed patient data and it is not possible to obtain an accurate real-time longitudinal view of a patient record.

### SUMMARY OF THE INVENTION

One aspect of the invention provides a computer-implemented method of promoting patient compliance with one or more recommended treatments. The computer-implemented method includes: receiving digital health information from a first healthcare provider, the digital health information specifying one or more recommended treatments; receiving at least one selected from the group consisting of: digital billing information and digital health information from one or more selected from the group consisting of: a second healthcare provider and a health benefits provider; and for one or more patients: parsing the digital health information received from a first healthcare provider to identify the one or more recommended treatments; parsing the digital billing information or digital health information received from the second healthcare provider or health benefits provider; and identifying whether a potential match exists between the one or more recommended treatments and the digital billing information or digital health information received from the second healthcare provider or health benefits provider.

This aspect of the invention can have a variety of embodiments. The computer-implemented method can further include presenting the potential match to the patient for confirmation of whether the potential match is accurate. The computer-implemented method can further include alerting one or more selected from the group consisting of: the patient, the first healthcare provider, and the benefits provider of an absence of a potential match. The one or more recommended treatments can include one or more selected from the group consisting of: consultation with a specialist, therapy, diagnostic testing, imaging, and medication.

Another aspect of the invention provides a computer-implemented method of promoting patient compliance with one or more recommended screening regimens. The computer-implemented method includes: receiving one or more selected from the group consisting of: demographic information, patient history, and family history from a patient; obtaining a list of recommended screenings for patients having the demographic information, patient history, or family history pertaining to a patient; receiving at least one selected from the group consisting of: digital billing information and digital health information related to the patient; parsing the digital billing information or digital health information; and identifying whether a potential match exists between the one or more recommended screenings and the digital billing information or digital health information.

This aspect of the invention can have a variety of embodiments. The computer-implemented method can further include presenting the potential match to the patient for confirmation of whether the potential match is accurate. The computer-implemented method can further include alerting one or more selected from the group consisting of: the patient, a healthcare provider, and a benefits provider of an absence of a potential match.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts an exemplary network topology according to an embodiment of the invention.

FIG. 2A depicts a typical interaction between a physician and a patient.

FIG. 2B depicts an interaction between a physician and a patient according to an embodiment of the invention.

FIG. 3 depicts a computer-implemented method of promoting patient compliance with one or more recommended treatments according to an embodiment of the invention.

FIG. 4 depicts a computer-implemented method of promoting compliance with one or more recommended screening regimens according to an embodiment of the invention.

FIG. 5 depicts data flows according to an embodiment of the invention.

FIG. 6 depicts a computer-implemented method of compiling, sharing, and/or managing a personal health record according to an embodiment of the invention.

### DEFINITIONS

The instant invention is most clearly understood with reference to the following definitions:

As used herein, the singular form “a,” “an,” and “the” include plural references unless the context clearly dictates otherwise.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

### DETAILED DESCRIPTION OF THE INVENTION

### Exemplary Network Topology

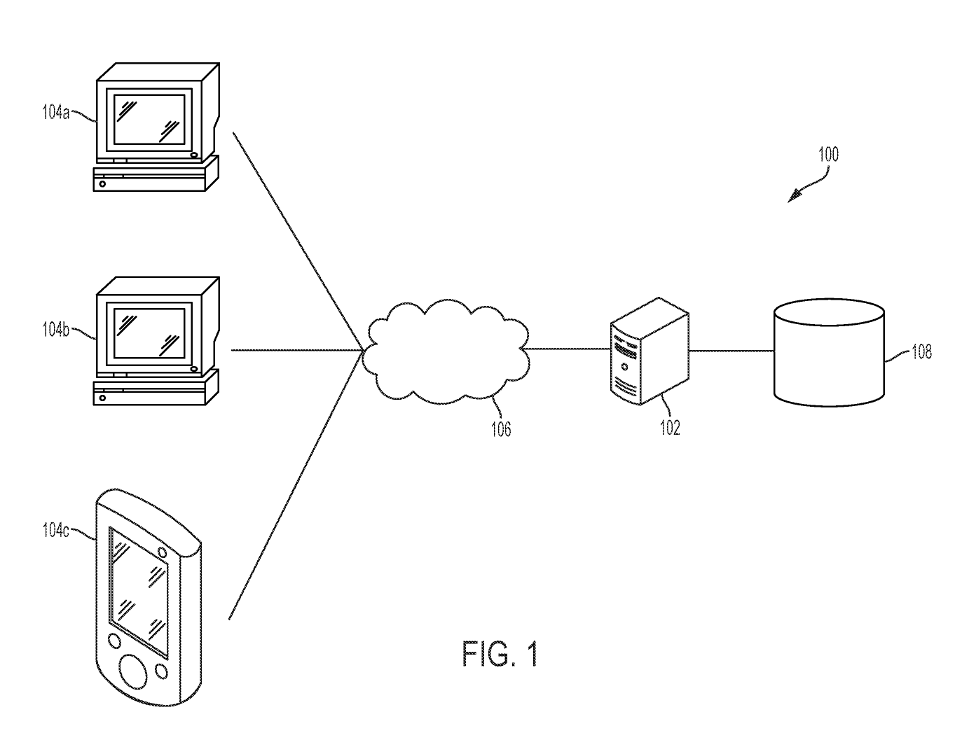

Referring to FIG. 1, an exemplary network topology 100 for an embodiment of the invention described herein is depicted. Embodiments of the invention can be implemented on server 102, which is in communication with clients 104a-c via network 106.

The terms “client” and “server” are used to reflect a client-server relationship between elements 102 and 104a-104c. Suitable devices for server element 102 include, but are not limited to general-purpose computers, including, but not limited to computers with higher processing power colloquially known as “servers.” Likewise, suitable devices for client elements 104a-104c include, but are not limited to general purpose computers, including, but not limited to desktop computers, laptop computers, tablet computers, personal digital assistants, cellular telephones, smartphones, video game systems, digital video recorders (DVRs), and the like.

Network 106 can be any network capable of transmitting data between clients 104a-104c and server 102, for example, an intranet or the Internet.

The server 102 can be in communication with a database 108. Database 108 can be operated through a database management system (DBMS). A DBMS is imposed upon the data to form a logical and structured organization of the data. A DBMS lies between the physical storage of data and the users and handles the interaction between the two. Examples of DBMSes include DB2® and INFORMIX®, both available from IBM Corp. of Armonk, N.Y.; MICROSOFT EXCEL®, MICROSOFT JET®, and MICROSOFT SQL SERVER®, all available from the Microsoft Corp. of Redmond, Wash.; MYSQL®, available from the MySQL Ltd. Co. of Stockholm, Sweden; ORACLE® Database, available from Oracle Intl Corp. of Redwood City, Calif.; and SYBASE®, available from Sybase, Inc. of Dublin, Calif.

Depending on the particular implementation, server 102 and/or clients 104a-c can be programmed to generate and/or display one or more graphical user interfaces that allow users to interact with the server 104 through graphical icons and visual indicators. For example, server 102 and/or clients 104a-c can include charts or graphs that can be generated on the fly using widgets such as the GOOGLE® CHART API, the CorePlot, iOSPlot, iOS:Chart, KeepEdge Library, and Shinobi Controls graphing libraries for the IOS™ operating system and the GraphView and AndroidPlot libraries for the ANDROID™ operating system.

### Personal Health Records

One embodiment of the invention provides a platform for the creation of a personal health record. The personal health record can be controlled by the patient and can include data from disparate sources such as patient Web portals provided by companies such as Epic Systems, WEBeDoctor, and Cerner in conjunction with electronic medical records systems, electronic medical records systems, insurance company websites, benefits administering firm (e.g., a flexible savings account administering firm) websites, manual entry by the patient or physician, and the like.

Although data imports from data sources (e.g., electronic medical record systems or health insurance systems) on an on-demand or a periodic basis (e.g., nightly) provide a powerful mechanism for obtaining well-formatted data on a regular basis, data imports often require significant time and resources to negotiate and implement both the technical and contractual aspects of such transfer (e.g., HIPAA compliance, Application Programming Interfaces, and the like). Accordingly, some embodiments of the invention utilize an adapter to interact with a particular portal. For example, if a patient indicates that her primary care provider is affiliated with Anytown Medical Associates and her health insurance is provided by InsCo, the platform can request log-in information from the patient (e.g., the URL for the portal, the patient's user name or ID, and password), access the patient portal(s), extract desired information, and incorporate this extracted information into a personal health record for the patient. In one embodiment, SELENIUM (available at seleniumhq.org), another emulator or software testing framework, or a macro is utilized to automatically interact with the portal without the need for human control. For example, the platform can be programmed to simulate mouse clicks and/or data entry at a defined coordinate and can capture text provided in response to certain inputs.

### Methods of Promoting Patient Compliance

One embodiment of the invention provides a mobile software patient engagement platform that offers an innovative solution to gaps in existing patient care management workflow. The platform can serve as an intelligent bridge between prescribed medical treatment and actual patient practice. The platform can help the patient engage in the coordination of their care and their health together with the physician. Embodiments of the invention include patient-controlled healthcare information aggregation and secure sharing, “Close The Loop” coordination of care features, and smartphone-based wellness app integration.

Embodiments of the invention enable patients to have a single aggregated representation of his health data pooled from the fragmented pictures currently available at each medical provider and payer website. Embodiments of the invention can assemble a personal health record (PHR) from any Web portal that allows patient access. This gives the patient a complete picture of their health care that they can share with whomever they choose. This can be achieved through a secure, patient-controlled, time-limited, “snap” share mechanism, and does not require physical proximity to the provider.

In some embodiments of the invention, the platform further analyzes the information found at all these portals (e.g., at log-on) to deliver a “Close The Loop” function for patients.

“Closing the Loop” can include providing the physician with information about the extent to which a patient has followed the recommended treatment advice. This may mean setting up a screening at a particular time, creating and keeping a follow-up appointment, having a test administered, taking medication, or performing home therapy. It is not currently possible for a physician to perform this level of monitoring outside of an in-patient setting; the time and resources are simply not available. Furthermore, a patient may not remember, may not be interested, or may not have the ability to follow the recommendations accurately. Closing the loop technology provides the physician with up-to-date information regarding patient compliance. This puts the physician in a better position to have a dialog with the patient and possibly offer alternative treatment if the patient is unable to comply with the original recommendations. This makes it easier for both the physician and the patient to complete the treatment process.

For example, the platform can crosscheck the patient's Electronic Medical Records (EMRs) with web portals to detect ordered labs, imaging studies, consults, prescriptions, and receipt of prior authorizations amongst lab providers, payer claims, hospitals, and payer authorizations. The platform can then verify completion of these recommended treatments in the prescribed period of time. In this manner, the platform can determine whether the patient and provider have “Closed The Loop” for treatment plans. For example, if the physician has written the order for a mammogram to be completed within a month, the platform can crosscheck billing records to see if the mammogram occurred and optionally remind the patient to complete it. If a patient visits a physician and receives a requisite for an echocardiogram, the platform can check the payer portal for prior authorization approval and then, ultimately, completion of the study. In addition, if the patient and physician wish, the platform can alert the physician that the ordered study or lab tests was completed or that the expected time period for completion passed without the study occurring.

In another embodiment, the platform can integrate with smart phones and applications (colloquially known as “apps”) that encourage wellness by encouraging patients to track healthy behavior. The platform will have a unique ability to present this clinical ontology in a precise and simple way, thus improving clinical workflow and quick access to relevant information and improving patient outcomes.

Embodiments of the invention bring the patient to the center of his care and gives him tools to effectively manage it. Presently, there are multiple sources of siloed patient data and it is not possible to obtain an accurate real-time longitudinal view of a patient record, let alone share or take the next step of running analytics and helping automate the process of “closing the loop.”

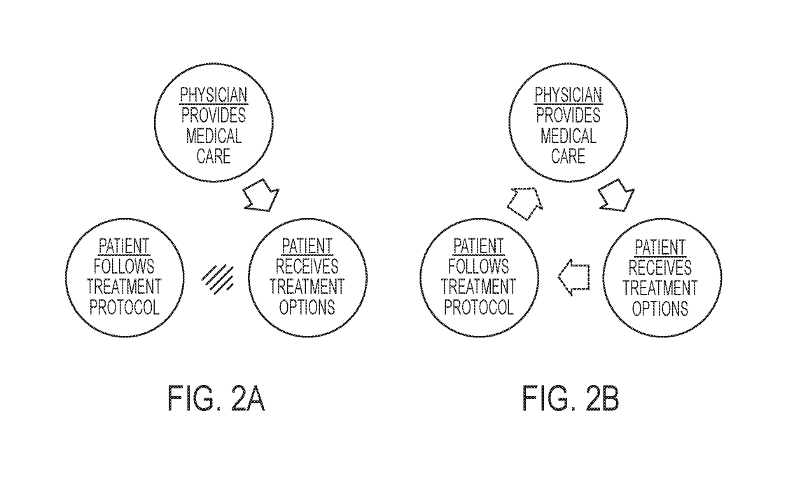

Referring now to FIG. 2A, in current practice, a patient is assessed and can be offered treatment options that they must implement. The patients may or may not be compliant, and the physician typically doesn't know whether the patient has complied with the treatment. Feedback for the physician commonly occurs when the patient is non-compliant and returns for related or further complaints.

Referring now to FIG. 2B, when the loop is closed (denoted by red arrows in the application as originally filed), it strengthens the patient's ability to be compliant with treatment, and notifies the physician whether the patient has been compliant or not.

Several examples of how the “Close the Loop” feature can benefit patients are provided below.

### Screening

In one example, the platform can assist the patient in adhering to standard screening recommendations based on the patient's age, sex, and/or other demographic information. The patient can first completes demographic information that is entered through the software platform. This patient data can be compared to a table of standard screenings and the screening algorithm identifies screenings for which the patient meets criteria. A customized list of screening recommendations can be constructed and passed to the patient's personal health record. The platform can search the patient's record for upcoming screenings and notify a patient when they are within a specified time interval (e.g., 6 months) of a recommended screening. Completed screenings can be manually entered by the patient and/or automatically marked as completed when the platform obtains data indicating that the screening occurred.

### Follow-Up Appointments

A physician can request that a patient have a follow-up appointment. The patient will often schedule this appointment immediately after the original visit. However, the patient is sometimes not prepared to make an appointment, the follow-up is beyond the timeframe for booking, or it is a follow-up recommended with a different physician (e.g., referred to a specialist). In this situation, the software platform can receive information regarding a follow-up appointment that is either manually entered by the patient, imported from a downloaded copy of the patient report, entered by the physician or her staff through a physician's account on the platform, or via a message from the physician's EHR system. The patient is reminded to make the appointment at a specified interval(s) in advance of the recommended appointment time (e.g., 90 days, then 60 days, etc.)). If the patient has made the appointment, he can mark this manually on their account and receive no further reminders. If the recommended date passes, the patient can receive further reminders. Based on configured user preferences, the physician can be alerted if the recommended screening date has passed.

### Patient-Administered Treatment

When a patient is asked to perform a certain treatment tasks (e.g., fill a medication, perform home therapy), the physician currently has little feedback on compliance with these recommendations. Embodiments of the “Close the Loop” feature will allow the physician to be informed of compliance with these recommendations. The patient's account can be updated with new treatment recommendations. These recommendations can originate from the patient manually entering the new treatment recommendations, the physician manually entering new treatment recommendations, or extraction from EMR/PHR data available online. A customized schedule can be created for each treatment option based on data that has been manually entered or pulled from online records. If the treatment involves filling a prescription, the patient can be provided with a reminder. This reminder will continue until the patient manually records fulfilling the prescription The platform will attempt to match this prescription filling against insurance data, and if there is no match, reminders will be sent to the patient and physician. Patients can be reminded through a notification component to perform treatment at the specified intervals. Completion of daily treatments can be recorded by the patient. Based on user preferences, the physician can be notified of a lack of following the recommended treatment.

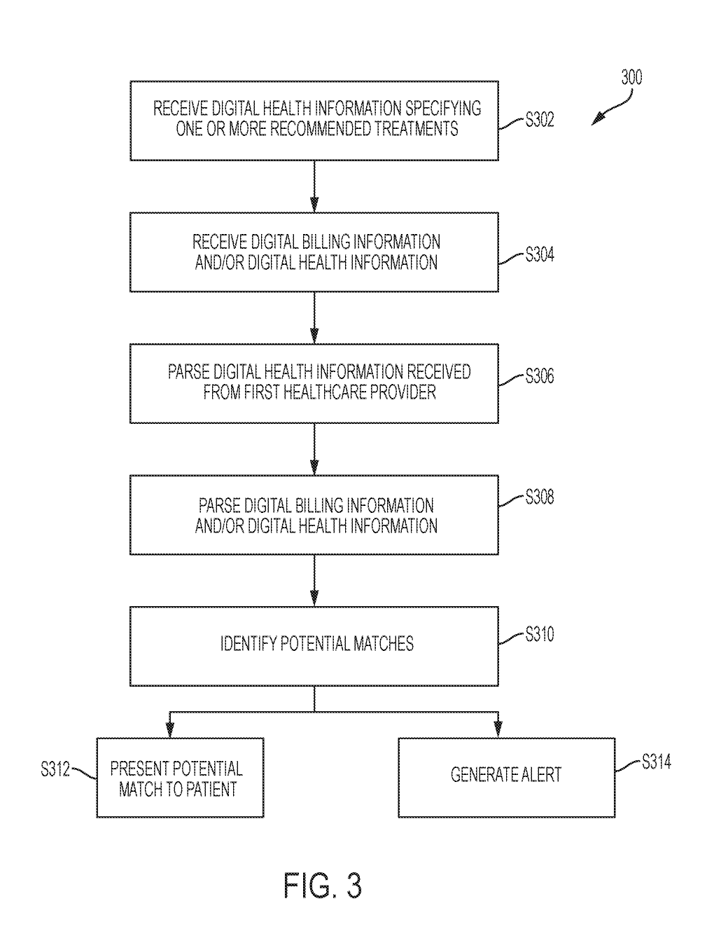

Referring now to FIG. 3, one embodiment of the invention provides a computer-implemented method 300 of promoting patient compliance with one or more recommended treatments.

In step S302, digital health information specifying one or more recommended treatments is received from a first healthcare provider. This digital health information can be received using the techniques described herein including data imports from the first healthcare provider and access to a patient portal.

In step S304, digital billing information and/or digital health information are received, for example, from the first healthcare provider, a second healthcare provider, and a health benefits provider. This digital billing information and digital health information can be received using the techniques described herein including data imports from the first healthcare provider and access to a patient portal.

In step S306, the digital health information received from a first healthcare provider is parsed to identify one or more recommended treatments.

In step S308, the digital billing information and/or the digital health information received from the second healthcare provider and/or the health benefits provider is parsed.

Various parsing techniques including preprocessing by tokenization, stop word removal, and/or lemmatization can be utilized. Examples of suitable parsing techniques are provided in U.S. Patent Application Publication Nos. 2010/0191731 and 2010/245358.

In step S310, one or more potential matches between the one or more recommended treatments and the digital billing information or digital health information received from the second healthcare provider or health benefits provider are identified. For example, if a first healthcare provider recommended that the patient undergo an echocardiogram, the platform can search the digital billing information and/or the digital health information received from the second healthcare provider and/or the health benefits provider to identify evidence that the electrocardiogram was performed.

In step S312, the potential match is presented to the patient for confirmation of whether the potential match is accurate.

In step S314, an alert is generated regarding the absence of a potential match.

Methods of Promoting Patient Compliance with Recommended Screening Regimens

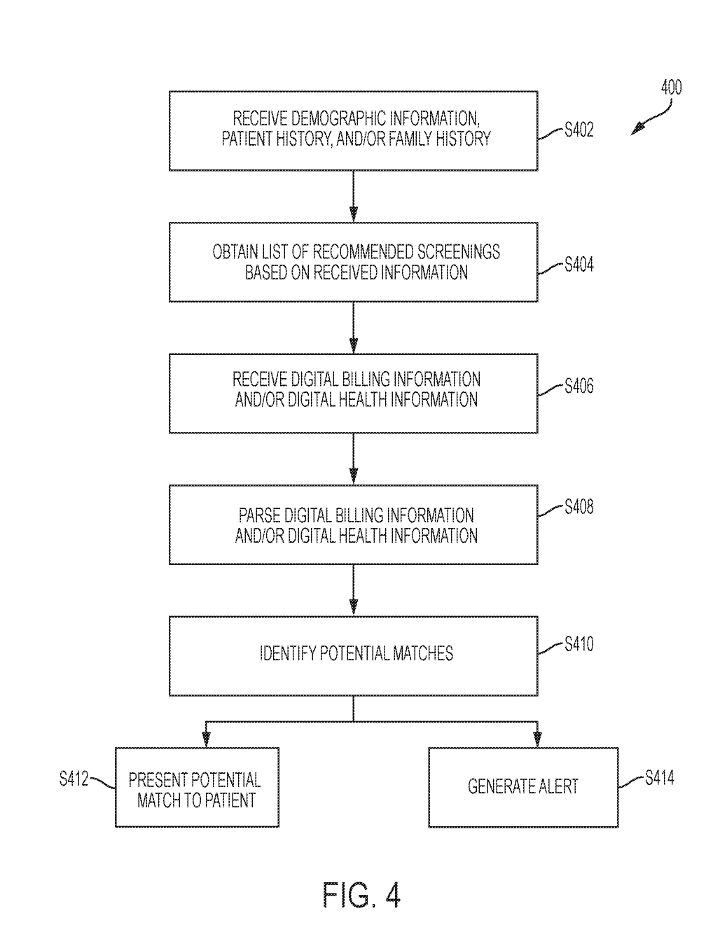

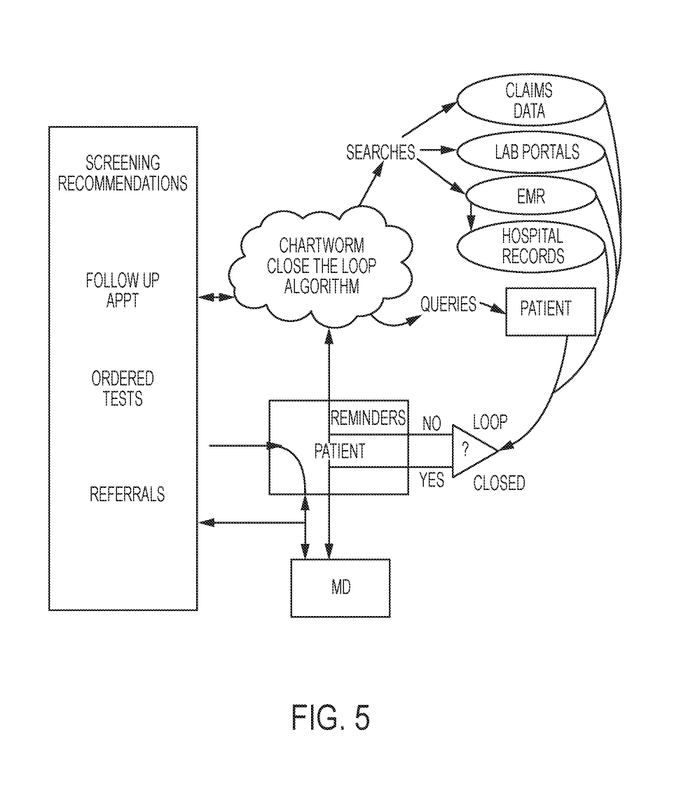

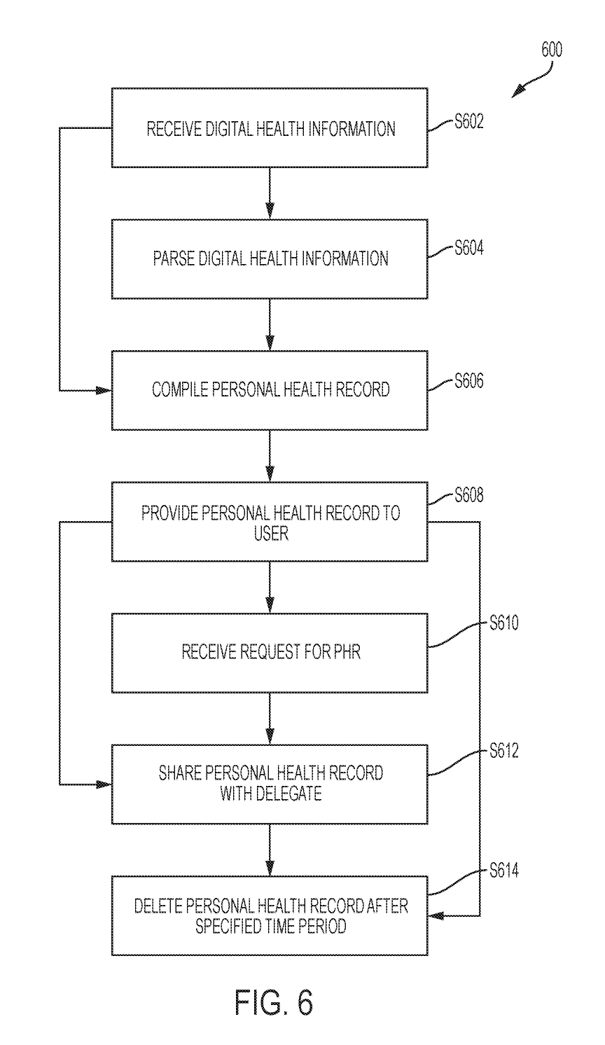

Referring now to FIG. 4, another aspect of the invention provides a computer-implemented method 400 of promoting compliance with one or more recommended screening regimens.

In step S402, demographic information, patient history, or family history pertaining to a patient is obtained. This information can be input directly by the patient, extracted from one or more data sources described herein, or obtained from another data source.

In step S404, a list of recommend screenings for patients is obtained. Exemplary lists are available from the U.S. Preventive Services Task Force at http://www.uspreventiveservicestaskforce.org/.

In step S406, digital billing information and/or digital health information are received, for example, from a healthcare provider and/or a health benefits provider. This digital billing information and digital health information can be received using the techniques described herein including data imports from the first healthcare provider and access to a patient portal.

In step S408, the digital billing information and/or digital health information is parsed as described herein.

In step S410, one or more potential matches between the one or more recommended screenings and the digital billing information or digital health information are identified.

In step S412, the potential match is presented to the patient for confirmation of whether the potential match is accurate.

In step S414, an alert is generated regarding the absence of a potential match.

### Actionable Alerts

In some embodiments, the alerts provided to the patient can be actionable. For example, if the patient has not filled a prescription, the alert can include a graphical user interface (GUI) element to dial a pharmacy of choice, a link to send a prescription to a pharmacy of choice, or a copy of the prescription for presentation to a pharmacist. Other GUI elements could include forms or links for requesting a follow-up appointment.

### Linking of Family Medical Histories

In some embodiments of the invention, a plurality of patients can provide access to all or a portion of their personal health records to another family member. For example, a child can identify her parents and request that they provide access to their medical records. The parents will then receive a request (e.g., via e-mail) and can approve or reject the request in-whole or in-part. For example, the parents may allow access to only the type of information that would typically be included in a family medical history (e.g., hereditary conditions such as cancers, heart diseases, allergies, and the like).

### Aggregate Data Analysis

In some embodiments of the invention, the platform can calculate aggregate data with regard to patient populations. For example, a physician's office can obtain reports including the percentage of patients that comply with the physician's recommendations and the characteristics of sub-groups of patients that are compliant or are not compliant.

### Access by Delegates of the Patient

In some embodiments of the invention, a patient can designate one or more individuals (e.g., family members) as delegates to receive all or certain information generated by the platform. For example, an elderly patient (who may or may not be comfortable with computers or capable of actively tracking necessary medical events) can designate their child to receive notifications about tests that are approaching or past due.

In some embodiments, the delegate can be a healthcare provider such as emergency room personnel. For example, the user can grant access to an emergency room physician to view their personal health record for a limited period of time as further discussed below. The user's PHR can be temporarily transferred a device controlled by the delegate and then deleted when the access expires.

The data accessed by the delegate can be maintained separately from the delegate's own data by storing the access data in a separate file or data structure.

### Temporal Restrictions

In some embodiments of the invention, the platform enforces temporal restrictions on the aggregation and/or retention of the user's personal health record. For example, the user can specify how long the personal health record is to be maintained at any time (e.g., when first registering with the platform or when compiling a personal health record from one or more data sources). Such an embodiment of the invention can be particularly useful when the user is consulting with a new healthcare provider (e.g., in an emergency situation). The user can select a desired period of time (e.g., 5 minutes, 1 hour, 1 day, and the like) and be assured that neither the healthcare provider (to whom the user may hand their smartphone or tablet) nor the platform will retain their personal health record after the desired period of time (except to the extent that the healthcare provider takes notes).

In some embodiments, the user can separately control the length of time that devices beyond of their possession (e.g., the server that aggregates the PHR) and in their possession (e.g., their smartphone, tablet, or personal computer) retain their data. For example, the user can elect that the platform will not maintain any copy of their personal health record beyond the time (a few seconds) required to obtain the necessary health data from the various data sources, compile the personal health record, and transmit to the personal health record to the user's device.

### Data Protection

Embodiments of the invention can utilize various techniquest and technologies to protect user data and meet or exceed the standards set forth by U.S. Department of Health and Human Services guidance on electronic PHI (Personal Health Information). For example, data can be encrypted using public/private key pairs so that the platform encrypts the personal health record with the user's public key and the user's private key can be used to decrypt the data. Data in transit can be encrypted using Transport Layer Security (TLS).

### Implementation in Computer-Readable Media and/or Hardware

The methods described herein can be readily implemented in software that can be stored in computer-readable media for execution by a computer processor. For example, the computer-readable media can be volatile memory (e.g., random access memory and the like) and/or non-volatile memory (e.g., read-only memory, hard disks, floppy disks, magnetic tape, optical discs, paper tape, punch cards, and the like).

Additionally or alternatively, the methods described herein can be implemented in computer hardware such as an application-specific integrated circuit (ASIC).

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A computer-implemented method of promoting patient compliance with one or more recommended treatments, the computer-implemented method comprising:
receiving digital health information from a first healthcare provider, the digital health information specifying one or more recommended treatments;
receiving at least one selected from the group consisting of: digital billing information and digital health information from one or more selected from the group consisting of: a second healthcare provider and a health benefits provider; and
for one or more patients:
parsing the digital health information received from a first healthcare provider to identify the one or more recommended treatments;
parsing the digital billing information or digital health information received from the second healthcare provider or health benefits provider; and
identifying whether a potential match exists between the one or more recommended treatments and the digital billing information or digital health information received from the second healthcare provider or health benefits provider.

2. The computer-implemented method of claim 1, further comprising:
presenting the potential match to the patient for confirmation of whether the potential match is accurate.

3. The computer-implemented method of claim 1, further comprising:
alerting one or more selected from the group consisting of: the patient, the first healthcare provider, and the benefits provider of an absence of a potential match.

4. The computer-implemented method of claim 1, wherein the one or more recommended treatments include one or more selected from the group consisting of: consultation with a specialist, therapy, diagnostic testing, imaging, and medication.

5. A computer-implemented method of promoting patient compliance with one or more recommended screening regimens, the computer-implemented method comprising:
receiving one or more selected from the group consisting of: demographic information, patient history, and family history from a patient;
obtaining a list of recommended screenings for patients having the demographic information, patient history, or family history pertaining to a patient;
receiving at least one selected from the group consisting of: digital billing information and digital health information related to the patient;
parsing the digital billing information or digital health information; and
identifying whether a potential match exists between the one or more recommended screenings and the digital billing information or digital health information.

6. The computer-implemented method of claim 5, further comprising:
presenting the potential match to the patient for confirmation of whether the potential match is accurate.

7. The computer-implemented method of claim 5, further comprising:
alerting one or more selected from the group consisting of: the patient, a healthcare provider, and a benefits provider of an absence of a potential match.
